(19) United States
(12) Patent Application Publication
(10) Pub. No.: US 2003/0110335 A1
(43) Pub. Date: Jun. 12, 2003

(54) BUS TRANSACTION BETWEEN DEVICES IN A SYSTEM

(75) Inventor: CHINH K. NGUYEN, SAN DIEGO, CA (US)

Correspondence Address: JOHN D. COWART, NCR CORPORATION, LAW DEPARTMENT, IP SECTION, ECD-2, 101 W. SCHANTZ AVE., DAYTON, OH, 45479, US

(73) Assignee: NCR CORPORATION, DAYTON, 45479 (US)

(21) Appl. No.: 09/593,033

(22) Filed: Jun. 12, 2000

(51) Int. Cl. G06F 13/00; G06F 13/38

(52) U.S. Cl. 710/107

(57) ABSTRACT

### Abstract of Disclosure

A method and apparatus of performing transactions over a bus includes sending, from a first device, an indication to start a bus transaction. Assertion of a predetermined indication from a second device is waited for. An indication that the first device is ready to transfer data over the bus is asserted after assertion of the predetermined indication. In one arrangement, the bus is a Peripheral Component Interconnect (PCI) bus.

### Background of Invention

The invention relates to bus transactions in a system, such as in a computer system or other device having processing or computing capabilities.

Many different types of processing systems are available to users. The types of systems range from computer systems (e.g., desktop systems, portable systems, servers), personal digital assistants (PDAs), electronic game devices, telephony devices, and so forth. A typical system includes various integrated circuit (IC) chips, such as microprocessors, microcontrollers, and memory devices, that may be coupled by a bus. One type of bus is the Peripheral Component Interconnect (PCI) bus, although other types of buses also exist.

With improvements in access speeds of IC devices, bus speeds have also increased to keep pace. For example, many original implementations of the PCI bus use a 33 megahertz (MHz) clock for transfer of control and data signals over the bus. More recently, 66-MHz bus speeds have increasingly been implemented in systems. In addition, increased bus widths have allowed increased data transfer bandwidth between devices coupled to a bus. For example, on a PCI bus, a data transfer may be a 32-bit data transfer or a 64-bit data transfer. For backwards compatibility, support for both types of data transfer widths is offered in many conventional systems.

A bus specification typically imposes a minimum setup time and a maximum output delay relative to a bus clock. Thus, within the parameters set forth by a bus specification and during a clock period, bus devices have to process various signals involved in a bus transaction. One source of delay that exists in an IC device is the delay associated with combinatorial logic. As clock frequencies have increased (and clock periods have decreased), the combinatorial logic delay has become a more significant source of delay. In some cases, due to excessive delay within a device, transaction failures have occurred due to an inability of some devices to perform the necessary processing within the reduced amount of time available for bus signal processing.

A need thus exists for an improved method and apparatus for processing signals exchanged over a bus in bus transactions.

### Summary of Invention

In general, according to one embodiment, a system includes a bus and first and second devices coupled to the bus. The first device is capable of performing a transaction that is one of plural types. The first device waits for receipt of a predetermined indication from the second device before sending a second indication to the second device that the first device is ready to perform the transfer.

Other features and embodiments will become apparent from the following description, from the drawings, and from the claims.

### Brief Description of Drawings

Fig. 1 is a block diagram of an embodiment of a system including a bus.

Fig. 2 illustrates components inside an integrated circuit (IC) device used in the system of Fig. 1 that contribute to timing delay.

Figs. 3 and 4 are timing diagrams of write transactions performed in accordance with an embodiment.

Figs. 5 and 6 are timing diagrams of read transactions performed in accordance with an embodiment.

Fig. 7 is a block diagram of logic in a bus device in accordance with an embodiment.

### Detailed Description

In the following description, numerous details are set forth to provide an understanding of the present invention. However, it will be understood by those skilled in the art that the present invention may be practiced without these details and that numerous variations or modifications from the described embodiments may be possible. For example, although reference is made to a Peripheral Component Interconnect (PCI) bus in the described embodiments, other embodiments may employ other types of buses.

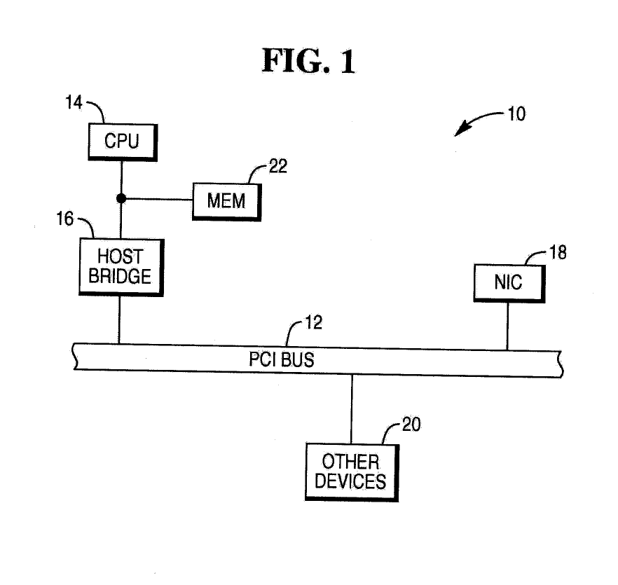

Referring to Fig. 1, a system 10 according to one example embodiment includes a system bus 12, which in the illustrated embodiment is a Peripheral Component Interconnect (PCI) bus. One version of the PCI bus is described in "PCI Local Bus Specification: Production Version,"Revision 2.2, dated December 1998. The system 10 may be a computer system (e.g., a desktop system, a portable system, a server, etc.), a personal digital assistant (PDA), an electronic game device, a telephony device, and so forth.

The PCI bus 12 is connected to various bus devices, including a network interface controller (NIC) 18, a host bridge 16, and other bus devices 20. The NIC 18 controls access to a network (not shown) that the system 10 may be connected to. The host bridge 16 is a bridge to a central processing unit (CPU) 14, which may be a microprocessor, a microcontroller, a set of microprocessors or microcontrollers, or any other type of processing or computing component. The CPU 14 and host bridge 16 may also be coupled to a memory subsystem 22. The other bus devices 20 that may be connected to the PCI bus 12 include hard disk controllers, compact disk (CD) or digital video disk (DVD) controllers, and so forth. The arrangement shown in Fig. 1 is by way of example only, as other embodiments may include other arrangements.

The PCI bus 12 has a clock signal running at a predetermined speed, e.g., 66 megahertz (MHz). A bus transaction occurring between any two of the devices on the PCI bus 12 is synchronized to the PCI bus clock. A setup time of an input signal to a bus device relative to the clock is specified by the PCI Specification, as is the output delay relative to the PCI bus clock for a device output to become valid. In one example, the setup time T_{SU} is approximately 3 nanoseconds (ns) and the output data valid delay T_{VAL} is approximately 6 ns maximum and 2 ns minimum. The setup time T_{SU} may be increased, but that comes at the expense of increased output delay time T_{VAL}.

In a typical bus transaction, handshaking sometimes occurs between two devices on the PCI bus 12. With the tight setup time T_{SU}, not much time is allocated for processing of signals on the PCI bus by combinatorial logic in the bus devices. Thus, for example, a first device may initiate a bus transaction targeted at a second device. After the bus transaction has been started, the first device may wait for a certain signal driven by a second device to become valid before performing the next action. With a relatively fast clock, the time period to perform this may be limited, leading to possible failure of the bus transaction.

In a PCI bus transaction, a "cycle frame" signal (FRAME# ) is driven by a master or initiator device to indicate the beginning and duration of a bus transaction. The FRAME# signal is asserted to indicate a bus transaction is beginning and remains asserted while the data transfers continue. When the FRAME# signal is deasserted, the transaction is in the final data phase or has completed. An "initiator ready" signal (IRDY#) indicates the bus master"s ability to complete the current data phase of the transaction. A "target ready" signal (TRDY#) indicates the ability of the selected device (or target device) to complete the current data phase of the transaction. The TRDY# signal is used in conjunction with the IRDY# signal, with both signals being asserted indicating the ability to proceed with the data transfer phase of a bus transaction. A data transfer phase is completed on any clock in which both the TRDY# and IRDY# signals are sampled asserted.

Also defined by the PCI Specification, a "device select" signal (DEVSEL#), when asserted, indicates that the device driving the signal has decoded its address as the target of the current access. A "request 64-bit transfer" signal (REQ64#), when activated by the master device, indicates that the current bus master desires to transfer data using 64 bits. If the REQ64# signal is deasserted, then a 32-bit data transfer is requested. An "acknowledge 64-bit transfer" signal (ACK64#), when activated by the target device, indicates that the target device has positively decoded its address as the target of the current access and indicates that the target is willing to transfer data using 64 bits.

Before assertion of the ACK64# signal, the master device does not know whether to perform a 32-bit or 64-bit data transfer. If a 32-bit data transfer, the master device drives (in a write transaction) or receives (in a read transaction) 32 bits of data (a double word) at a time. If a 64-bit data transfer, the master device drives or receives 64 bits of data at a time. Thus, conventionally, upon receiving either the asserted or deasserted state of the ACK64# signal, the master device needs to make a decision (within tight timing limits) on whether to perform a 32-bit or 64-bit data transfer. In bus transactions performed in conventional systems, the IRDY# signal is asserted before the ACK64# signal. Thus, very little time is provided for the decoding of the ACK64# signal.

One technique for easing this timing problem is by asserting the IRDY# signal after assertion of the DEVSEL# signal, thereby giving the master device substantially more time to decode the ACK64# signal. Although reference is made to specific signals according to the PCI Specification in describing the several embodiments, further embodiments may involve other signals according to the PCI Specification or other bus specifications.

Thus, generally, a master device initiates a bus transaction by asserting an indication of the start of the bus transaction. A target address is also provided by the master device with the start indication. The master device does not assert an initiator ready indication until after the target device has asserted a device select indication to indicate that the target device has successfully decoded the target address. This gives the master device an increased amount of time during which the master device can decode signals generated by the target device, such as a signal indicating one of several data transfer widths for the bus transaction.

As used here, a signal is "asserted"if it is at an active state. A signal is "deasserted"if it is at an inactive state. An "indication"may refer to a signal or a group of signals.

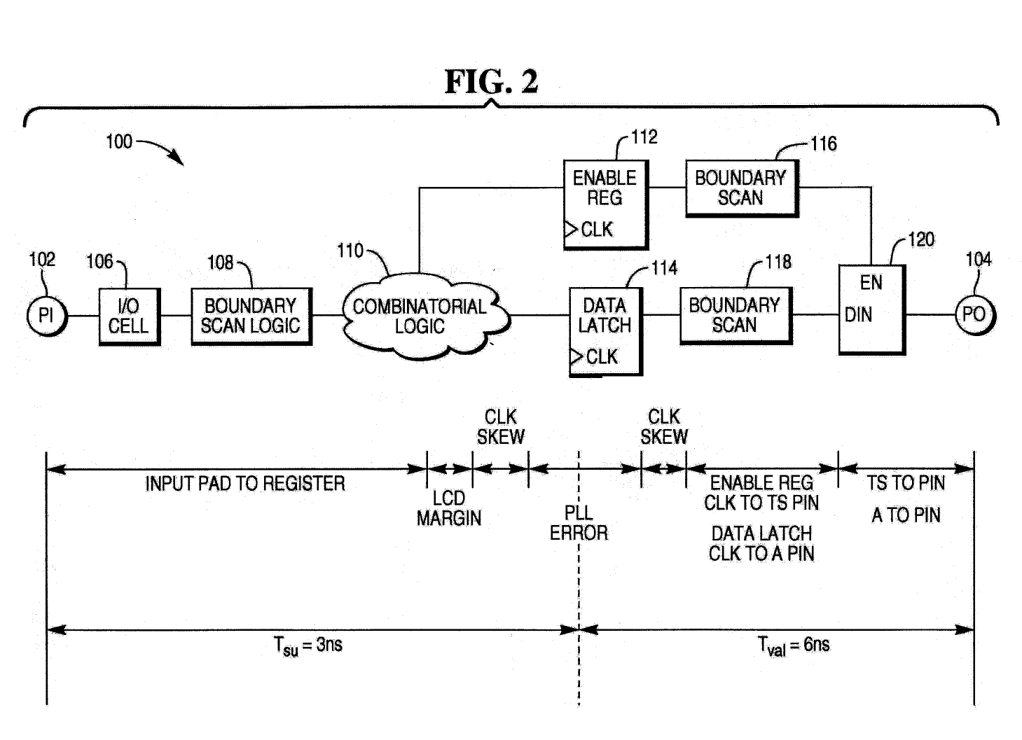

Referring to Fig. 2, the elements of an example bus device (referred to generally as 100) are illustrated. An input pin 102 and an output pin 104 are illustrated. The input pin 102 is coupled to an input/output (I/O) cell 106, which in turn is connected to a boundary scan circuit 108. In addition, combinatorial logic 110 is provided in the device 100 to process various PCI signals, including those discussed above. The combinatorial logic 110 is further connected to inputs of an enable register 112 and a data latch 114. Each of the enable register 112 and data latch 114 is clocked by an internal clock based on the PCI bus clock. The output of the enable register 112 leads to a boundary scan circuit 116, and the output of the data latch 114 leads to a boundary scan circuit 118. Outputs from the boundary scan circuits 116 and 118 are fed to an output cell 120, which is enabled by a signal from the enable register 112. The data presented on the output pin 104 is from the data latch 114 through the output cell 120.

As shown in Fig. 2, the input signal setup time T_{SU} is approximately 3 ns, while the output valid delay time T_{VAL} is approximately 6 ns (maximum). Each of the elements in the device 100 is associated with some delay, including delays associated with data transfer through the input pin 102, the I/O cell 106, the boundary scan logic 108, and the combinatorial logic 110. In addition, an LCD (linear combination of delays) margin, clock skew, and phase locked loop (PLL) error adds to the overall delay. With a 3 ns setup time, the available time for the combinatorial logic 110 to process signals is less than 3 ns. In some cases, the observed maximum time allowed for decoding by the combinatorial logic 110 is about 2 ns.

On the output side, the output delay time includes a portion of the PLL error, clock skew, the larger of the delay from the enable register 112 or the data latch 114 to the output cell 120, and the larger of the delay from the enable input of the output cell 120 or the data input of the output cell 120 to the output pin 104.

The amount of time provided the combinatorial logic 110 to perform signal decoding may not be sufficient, particularly for decoding the ACK64# signal driven by the target bus device. The same may also be true for any other signal in which the action to be performed by the master device is dependent upon a signal provided by the target device. To give a master bus device more time to process the ACK64# signal in accordance with some embodiments, the initiator ready signal IRDY# is delayed until after the device select signal DEVSEL# has been asserted by the target device.

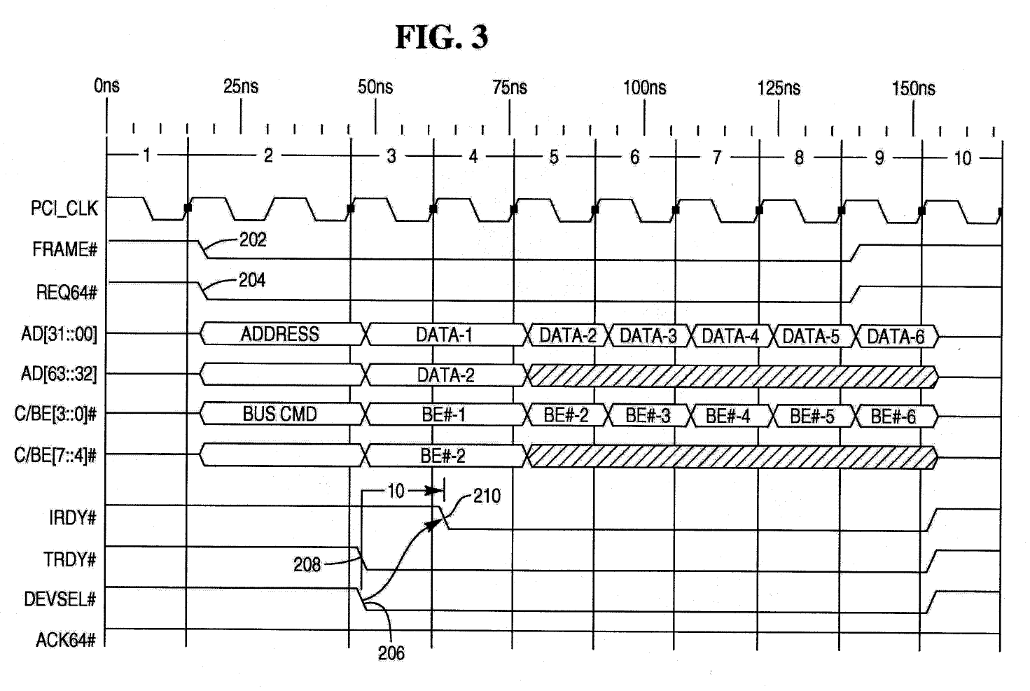

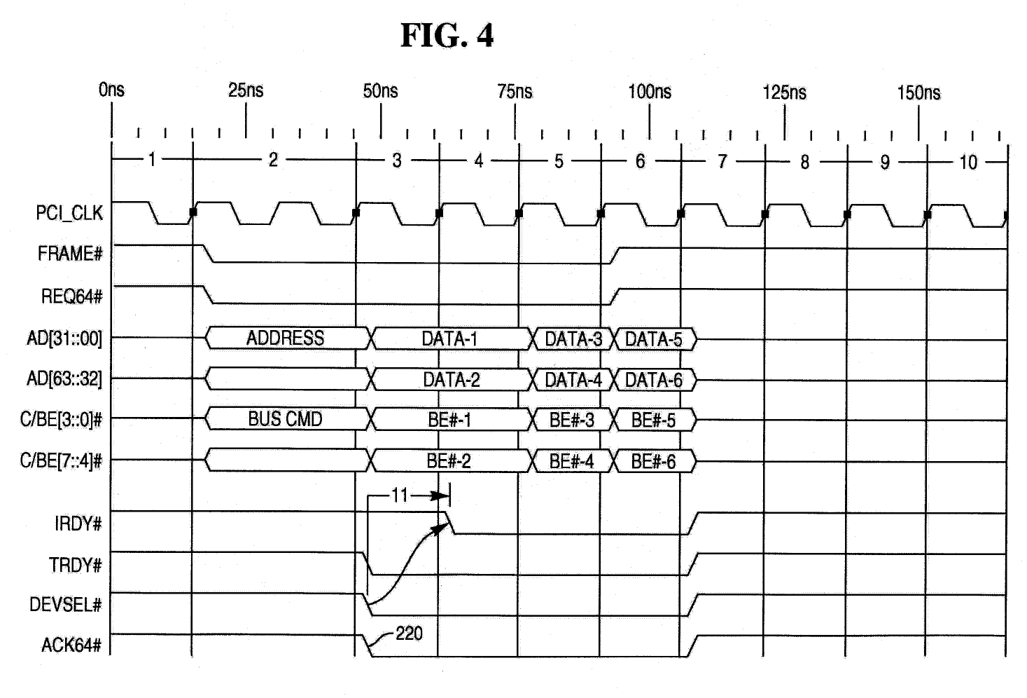

Fig. 3 shows a write transaction with 32-bit data transfer, and Fig. 4 shows a write transaction with a 64-bit data transfer, in accordance with some embodiments. The PCI bus clock is PCI_CLK. The bus transaction is started with assertion of FRAME# (at 202) by the master device. The master device also asserts REQ64# (at 204) to request a 64-bit data transfer. The address signals AD[31::00] and AD[63::32] are asserted in the same cycle in which FRAME# is asserted. In addition, a bus command (in this case a write command) on C/BE[3::0]# and C/BE[7::4]# is presented in the same cycle as FRAME# being asserted.

The target device asserts DEVSEL# to indicate that it has decoded the address presented by the master device in the current bus transaction. The target device also asserts the target ready signal TRDY# to indicate that it is able to complete the current data phase of the transaction.

After receiving activation of TRDY#, the master device places the first 32-bits of data (DATA-1) and the second 32-bits of data (DATA-2) on AD[31::00] and AD[63::32], respectively. Effectively, the master device is assuming a 64-bit data transfer at this point until ACK64# indicates otherwise.

In the next cycle, after detecting activation of DEVSEL#, the master device asserts IRDY# (at 210). With the assertion of IRDY# by the master device, the combinatorial logic 110 in the master device decodes the state of ACK64#, which in this case is inactive because the target device is unable to perform a 64-bit data transfer. Because IRDY# is delayed until after assertion of DEVSEL#, the master device has an entire clock period (the one in which IRDY# is asserted) to decode ACK64#. In the next bus cycle, since a 32-bit data transfer is being performed, the master device presents the second 32-bits of data (DATA-2) on AD[31::00], followed by subsequent double words (32-bits of data) DATA-3, DATA-4, DATA-5, DATA-6 and so forth, all on AD[31::00].

Fig. 4 shows a write transfer in which both the master device and the target device are capable of performing 64-bit data transfers. The timing of all the signals shown in Fig. 4 are identical to those in Fig. 3, except that ACK64# is asserted low by the target device (at 220). In the next bus cycle, after the master device has detected assertion of DEVSEL# and asserted IRDY#, the combinatorial logic 110 in the master device decodes the state of ACK64#, which in this case is active. As a result, all 64-bits of data presented on AD[31::00] and AD[63::32] have been transferred successfully into the target device. In the next cycle, the next 64-bits of data (DATA-3 and DATA-4) are presented on AD[31::00] and AD[63::32], follow subsequently by successive 64-bits of data.

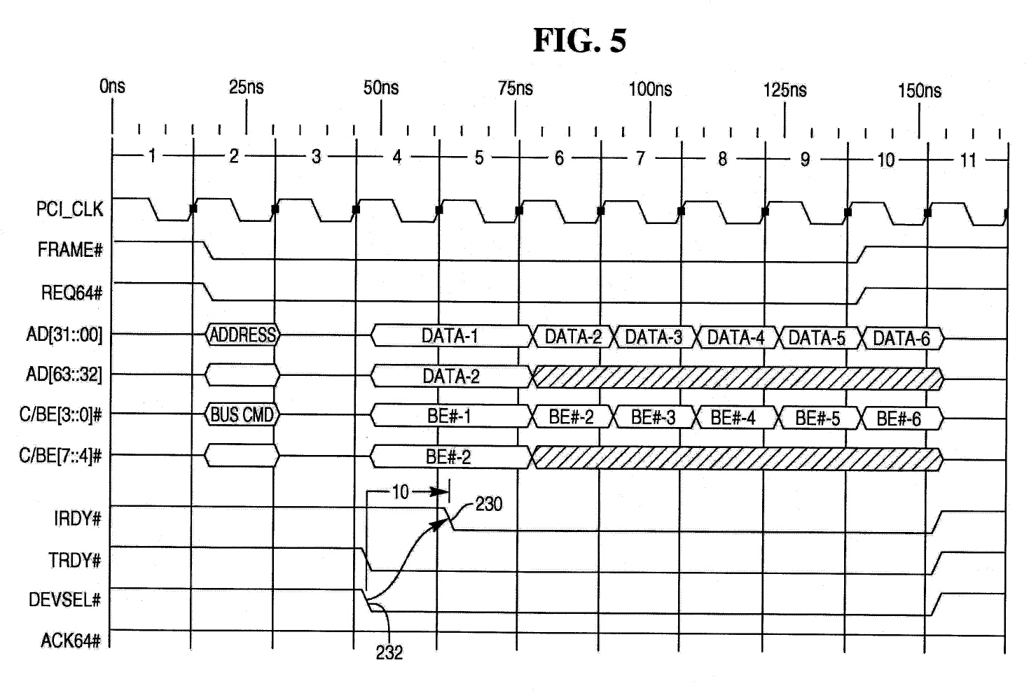

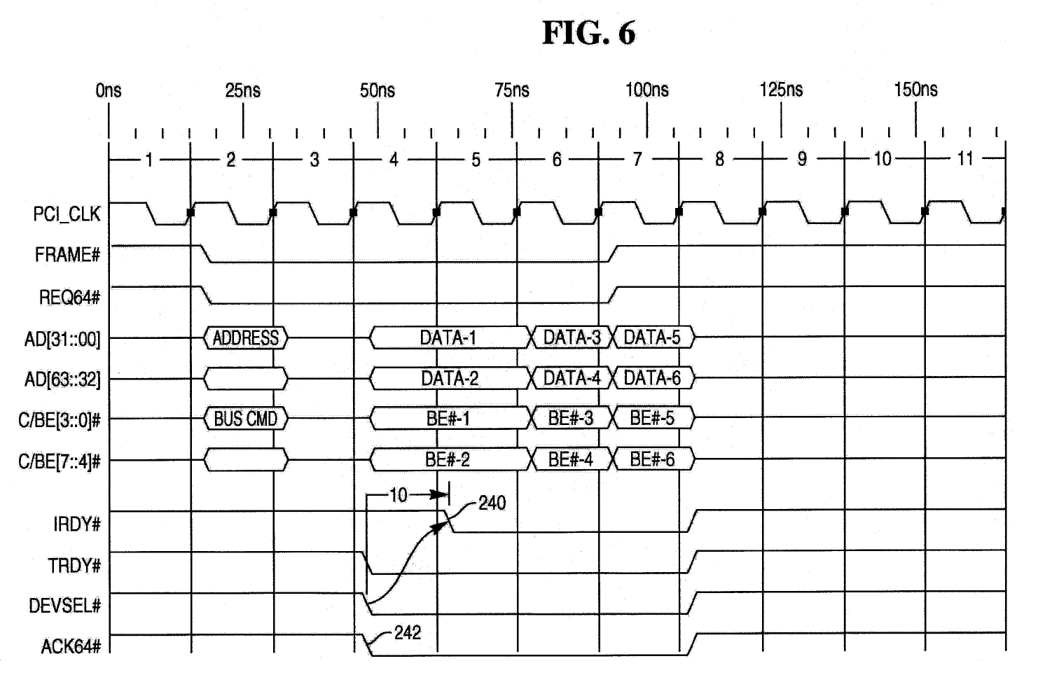

Fig. 5 shows a read transaction with a 32-bit transfer, and Fig. 6 illustrates a read transaction with a 64-bit transfer, in accordance with some embodiments. The timings of the signals in the read transaction of Fig. 5 are the same as those in Fig. 3. However, in the Fig. 5 bus transaction, the command signals C/BE# specify a read transaction and the data placed on the PCI bus 12 is driven by the target device instead of the master device. Also, the AD[31::00], AD[63::32], C/BE[3::0]#, and C/BE[7::4]# signals are tristated for at least one clock period between when the master device places the valid address and command on the bus and when the target device drives the data and byte enable signals.

Upon assertion of IRDY# (at 230) after DEVSEL# has been asserted (at 232), the master device is able to decode ACK64# to determine whether it is reading 32 bits of data or 64 bits of data in the read transaction. In Fig. 5, 32 bits of data are read at a time on AD[31::00] since the ACK64# remains inactive to indicate that the target device is unable to perform a 64-bit data transfer.

The signals in the read transaction of Fig. 6 have the same timings as signals in the read transaction of Fig. 5, except that the ACK64# signal is asserted low (at 242) by the target device to specify a 64-bit data transfer. After IRDY# has been asserted (at 240), the master device decodes that the ACK64# signal has been activated. In this case, the master device reads in 64-bits of data in each bus cycle.

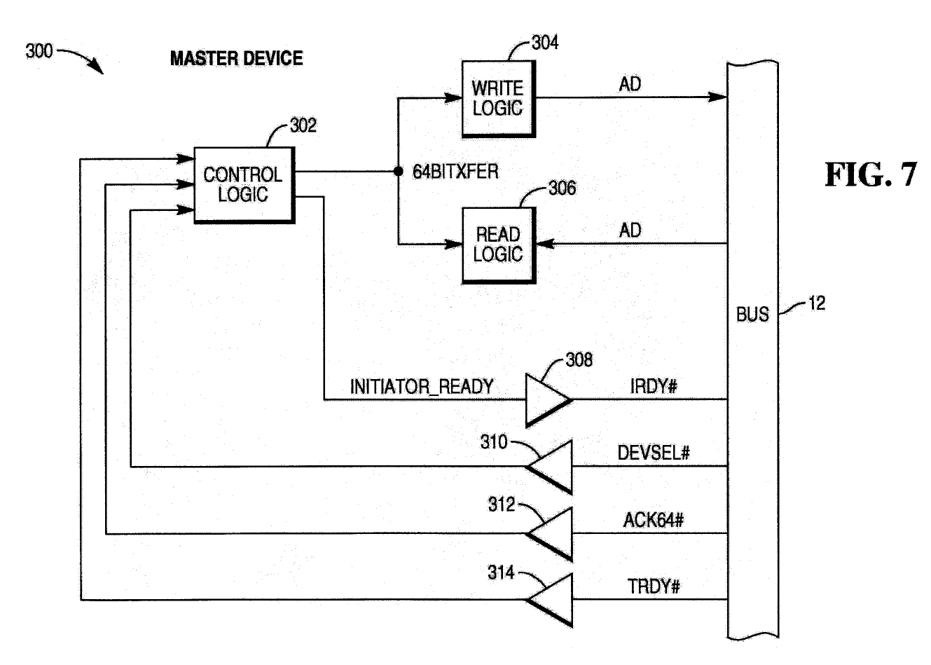

Referring to Fig. 7, the logic in a master device 300, which may be any one of the bus devices in the system 10 of Fig. 1, is illustrated. Write logic 304 controls the generation of write data on the AD signals, and read logic 306 controls the receiving of read data on the AD signals. A signal 64BITXFER generated by a control logic 302 indicates to the write and read logic 304 and 306 whether to write or read 32 bits or 64 bits of data in each bus cycle.

The device 300 includes input buffers 310, 312, and 314 to receive the DEVSEL#, ACK64#, and TRDY# signals, respectively. The input buffers 310, 312, and 314 drive the states of DEVSEL#, ACK64#, and TRDY# to the control logic 302. After DEVSEL# is asserted, the control logic 302 drives a signal INITIATOR_READY active to assert the IRDY# signal through an output buffer 308. Also, after the INITIATOR_READY signal is asserted, the control logic 302 samples the state of ACK64# to determine whether the cycle involves a 32-bit or 64-bit data transfer. From this determination, the control logic 302 drives 64BITXFER to the appropriate state (active or inactive).

A method and apparatus has been described that enables a master device to have more time to decode specified signals. One such signal is the ACK64# signal driven by the target device to indicate a 32-bit or 64-bit data transfer. By delaying the initiator ready signal IRDY# until after the target device has asserted DEVSEL#, indicating that the target device has decoded the address of the current bus transaction, an extra period is added to allow the master device time to decode the state of ACK64# after it becomes valid. With tight timing specification and a fast bus clock, such extra time provides the master device the ability to avoid race conditions when decoding ACK64# and other like signals on the bus. As a result, the likelihood of failed transactions on a bus is reduced to improve the reliability of system performance.

While the invention has been disclosed with respect to a limited number of embodiments, those skilled in the art will appreciate numerous modifications and variations therefrom. It is intended that the appended claims cover all such modifications and variations as fall within the true spirit and scope of the invention.

Claims

1.A method of performing transactions over a bus, comprising:
sending, from a first device, an indication to start a bus transaction;
waiting for assertion of a predetermined indication from a second device; and
asserting an indication that the first device is ready to transfer data over the bus after assertion of the predetermined indication.
2.The method of claim 1, further comprising the first device providing a target address on the bus, wherein waiting for assertion of the predetermined indication comprises waiting for assertion of a signal indicating that the second device has decoded the target address.

2. 3.The method of claim 2, wherein waiting for assertion of the predetermined indication comprises waiting for assertion of a PCI device select signal.

3. 4.The method of claim 1, wherein sending the indication to start the bus transaction comprises sending a PCI cycle frame signal.

4. 5.The method of claim 1, wherein asserting the indication that the first device is ready to transfer data comprises asserting a PCI initiator ready signal.

5. 6.The method of claim 1, further comprising decoding, in the first device, a signal indicating if a first type transaction or a second type transaction is to be performed.

6. 7.The method of claim 6, wherein decoding the signal is performed in a time period between assertion of the predetermined indication and assertion of the indication that the first device is ready to transfer data over the bus.

7. 8.The method of claim 6, wherein decoding the signal comprises decoding a signal indicating data transfer of one of plural widths.

8. 9.The method of claim 6, wherein decoding the signal comprises decoding a PCI acknowledge 64-bit transfer signal.

9. 10.A device for use in a system having a bus, comprising:
a controller capable of performing a transaction that is of one of plural types depending on a response from a target component on the bus;
a bus interface to receive a first indication from the target component; and
the controller adapted to wait for the first indication before generating a second indication that the device is ready to perform the transaction.

10. 11.The device of claim 10, wherein the plural types comprise plural data transfer widths.

11. 12.The device of claim 10, wherein the first indication comprises an indication that the target component has decoded an address associated with the transaction.

12. 13.The device of claim 10, wherein the first indication comprises a PCI device select signal.

13. 14.The device of claim 10, wherein the second indication comprises a PCI initiator ready signal.

14. 15.The device of claim 10, wherein the controller is adapted to further decode a third indication to determine which of the plural types of transaction to perform.

15. 16.The device of claim 15, wherein the third indication comprises a PCI acknowledge 64-bit transfer signal.

16. 17.A system comprising:
a bus; and
first and second devices coupled to the bus,
the first device capable of performing a transaction that is one of plural types,
the first device to wait for receipt of a predetermined indication from the second device before sending a second indication to the second device that the first device is ready to perform the transfer.

17. 18.The system of claim 17, wherein the bus comprises a Peripheral Component Interconnect bus.

18. 19.The system of claim 18, wherein the predetermined indication comprises a device select signal.

19. 20.The system of claim 19, wherein the second indication comprises an initiator ready signal.

20. 21.The system of claim 18, wherein the second indication comprises an initiator ready signal.

21. 22.The system of claim 17, wherein the plural types of transactions comprise a 32-bit data transfer transaction and a 64-bit data transfer transaction.
